(19) United States
(12) Patent Application Publication
(10) Pub. No.: US 2011/0120067 A1
(43) Pub. Date: May 26, 2011

(54) FILTER, FILTER ASSEMBLY WITH THE FILTER AND COOLING APPARATUS WITH THE FILTER ASSEMBLY

(76) Inventor: Jae Nyun KIM, Seoul (KR)

(21) Appl. No.: 12/823,848

(22) Filed: Jun. 25, 2010

(30) Foreign Application Priority Data
Nov. 25, 2009 (KR) 10-2009-0114294

(51) Int. Cl. B01D 50/00; B01D 39/00; B01D 46/42

(52) U.S. Cl. 55/385.1; 55/486; 55/483

(57) ABSTRACT

There is provided a filter including elements, each being made from non-woven fabric, which are placed on one right after the other, the two outermost elements being coated with a waterproof agent. The filter according to the present invention provides an advantage of permitting air to smoothly pass through it and effectively removing moisture and fine dust particles from air passing through it, as well as preventing production of static electricity. Furthermore, the filter can be manufactured with ease.

### BACKGROUND OF THE INVENTION

1. Field of the Invention

The present invention relates to a filter, a filter assembly with the filter, and cooling apparatus with the filter assembly.

2. Description of the Conventional Art

An electronic device for telecommunication is installed inside a housing with cooling apparatus. The cooling apparatus removed the amount of heat. If the cooling apparatus is faulty, the electronic device overheats and causes internal damage. The cooling apparatus includes a heat exchanger and cooling apparatus.

The cooling apparatus, disclosed in Korean patent registration No. KR 10-0606523 includes fans, installed inside the housing with an air inlet and air outlet, and a motor. The motor rotates the fan. The fan pulls outside air into the housing.

The electronic device is installed inside the housing. The electronic device is maintained at less than 65° C. for its proper operation. The electronic device is sensitive to moisture and fine dust particles. Moisture and fine dust particles have to be removed before outside air is introduced into the housing.

To do this, a filter is installed in front of each of the air inlet and air outlet in the housing. The filter includes a frame, a porous element, and a sealing agent (or a shaped body) attaching the porous element to the frame.

The porous element has pores, an average size of which is in the range of 0.5 to 20 μm (included). The porous element is waterproof.

Moisture and fine dust particles are removed from outside air passing through the porous element. Outside air, from which moisture and fine dust particles are removed, picks up heat produced by the electronic device and then passes through the air outlet to carry it away. As a result, the electronic device is made cooler.

The porous element may be made from ePTFE (expended-Poly Tetra Fluor Ethylene), woven fabric, or hosiery. However, porous ePTFE is difficult to make from fluorocarbon resin, such as Teflon.

Furthermore, ePTFE is subject to production of static electricity. Static electricity, occurring when the porous element is touched, causes the porous element to be damaged. So, the porous element should be wrapped with a sheet of paper, instead of a packing material made of polyvinyl resin producing static electricity.

The porous element, made from woven fabric, or hosiery, has pores of the same size. However, the size of the pores is too small and the pores are closely spaced in a uniform manner. This prevents smooth introduction of outside air into the housing.

### SUMMARY OF THE INVENTION

One object of the present invention is to provide a filter capable of permitting air to smoothly pass through it and effectively removing moisture and fine dust particles from air passing through it, a filter assembly equipped with the filter, and cooling apparatus equipped with the filter assembly.

Another object of the present invention is to provide a filter capable of being manufactured with ease and of preventing production of static electricity, a filter assembly equipped with the filter, and cooling apparatus equipped with the filter assembly.

According to one aspect of the present invention, there is provided a filter including elements, each being made from non-woven fabric, which are placed on one right after the other, the two outermost elements being coated with a waterproof agent.

According to another aspect of the present invention, there is provided a filter assembly including a filter frame, and a filter provided on the filter frame, the filter including elements, each being made from non-woven fabric, which are placed on one right after the other, the two outermost elements being coated with a waterproof agent.

According to another aspect of the present invention, there is provided cooling apparatus including a housing having an air inlet and an air outlet, inside which to install an electronic device, a fan provided inside the housing, pulling outside air into the housing, a fan motor driving the fan, and two filter assemblies being inserted into the air inlet and air outlet, respectively, each of the two filter assemblies including a filter frame, and a filter provided on the filter frame, the filter including elements, each being made from non-woven fabric, which are placed on one right after the other, the two outermost elements being coated with a waterproof agent.

The foregoing and other objects, features, aspects and advantages of the present invention will become more apparent from the following detailed description of the present invention when taken in conjunction with the accompanying drawings.

### BRIEF DESCRIPTION OF THE DRAWING

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a cross-sectional view of cooling apparatus, equipped with one embodiment of a filter assembly according to the present invention;

FIG. 2 is a perspective view of the filter assembly as shown in FIG. 1;

FIG. 3 is a cross-sectional view of the filter assembly cut along a line III-III, as shown in FIG. 2;

FIG. 4 is a perspective view of a filter as shown in FIG. 2;

FIG. 5 is a front view of a portion of the filter assembly as shown in FIG. 2;

FIG. 6 is a perspective view of a mold for casting the filter assembly as shown in FIG. 2;

FIG. 7 is an expanded, perspective view of a portion of the filter assembly as shown in FIG. 3;

FIG. 8 is a picture of a dissembled portion of the one embodiment of the filter according to the present invention; and

FIG. 9 is a picture of an expanded surface of a second or third element making up the filter as shown in FIG. 8.

### DETAILED DESCRIPTION OF THE PREFERRED EMBODIMENT

Referring to the accompanying drawings, a filter, a filter assembly equipped with the filter, and cooling apparatus equipped with the filter assembly according to the present invention.

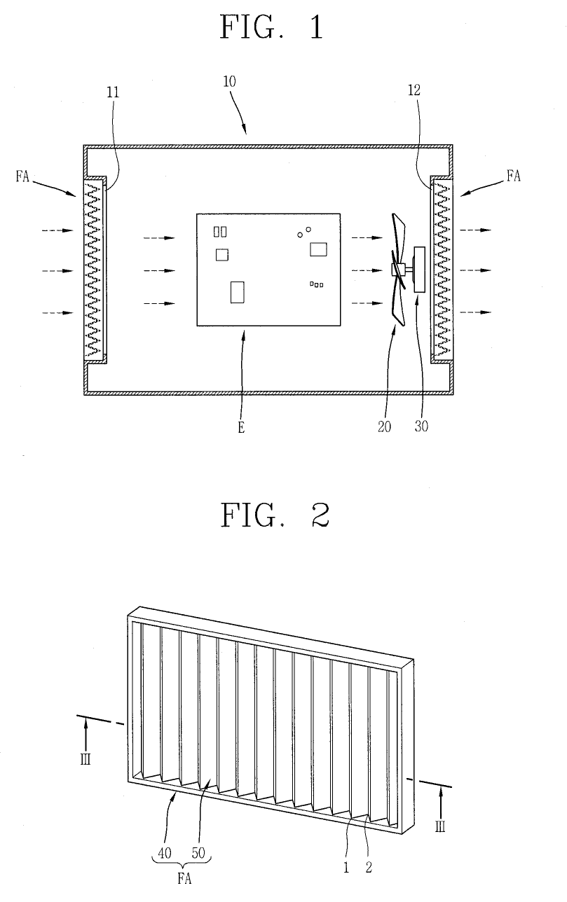

FIG. 1 is a cross-sectional view of cooling apparatus, equipped with one embodiment of a filter assembly according to the present invention. A dotted-line arrow indicates a direction in which air flows.

As shown in FIG. 1, an electronic device E is installed inside a housing 10 with an air inlet 11 and air outlet 12 on the opposite sides. The housing 10 is placed outdoors on a concrete slab. The housing 10 protects the electronic device E from exposure to the weather and damage from the surrounding atmosphere.

The cooling apparatus is installed inside the housing 10. The cooling apparatus permits outside air to flow into the housing 10 through the air inlet 11, pick up heat, and carry away through the air outlet 12.

The cooling apparatus includes a fan 20, a motor 30, and a filter assembly FA.

The fan 20 and motor 30 are installed adjacent to the air outlet 12 inside the housing 10. The two filter assemblies FA may be installed inside the housing 10: one in line with the air inlet 11 and the other in line with the air outlet 12.

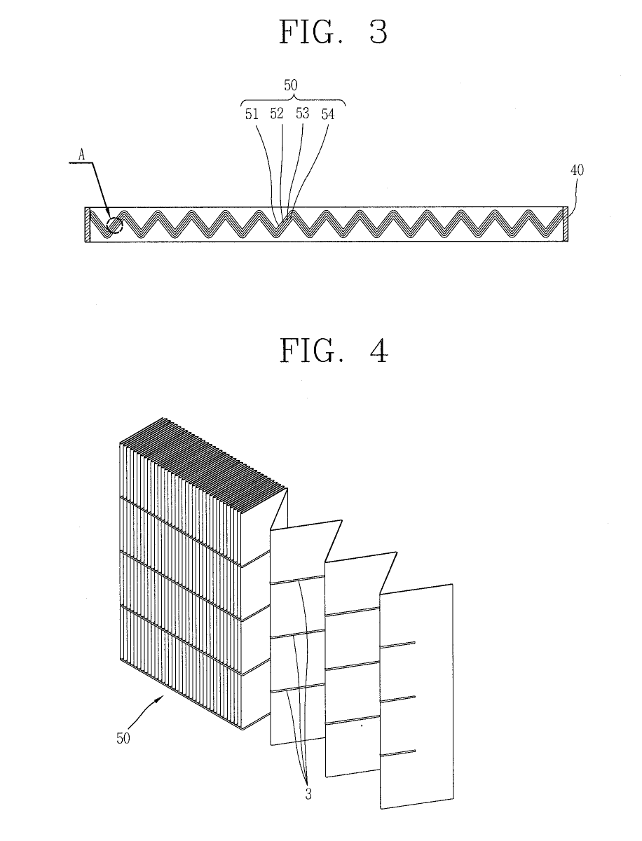

FIG. 2 is a perspective view of the filter assembly as shown in FIG. 1.

As shown FIGS. 1 and 2, the filter assembly FA includes a filter frame 40 and a filter 50.

The filter frame 40 may be made of resin including urethane resin. The filter frame 40 may be made of aluminum, stainless steel, or plastic. The filter frame 40 has a rectangular hole in the middle. The rectangular hole in the filter frame 40 varies depending on a shape of the air inlet or air outlet 11 or 12.

The filter 50, shaped like a rectangle, is inserted into the rectangular hole in the filter frame 40.

FIG. 3 is a cross-sectional view of the filter assembly cut along a line III-III, as shown in FIG. 2. FIG. 4 is a perspective view of a filter as shown in FIG. 2.

As shown in FIG. 3, the filter 50 is corrugated to maximize its filtering area. That is, the filter 50 is shaped into alternating ridges 1 and grooves 2.

As shown in FIG. 4, three support lines of olefin resin are formed on the upper, middle, and lower portion of the filter 50. The three support lines 3 of olefin resin serve to keep the filter 50 corrugated firmly in place within the filter frame. Thus, a given distance between the two adjacent ridges remains maintained.

The number of the support lines 3 of olefin resin is not limited to 3 (three). The support lines 3 of poly olefin resin, ploy ethylene resin, or poly propylene resin may be formed on the filter 50.

One end of each of the support lines is extended to one-half to two-thirds (included) of width of one outermost inclined surface of the filter 50, which is defined by both the one outermost ridge on the filter 50 and the one end of the filter 50, and the other end of each of the support lines 3 is extended to one-half to two-thirds (included) of width of the other outermost inclined surface of the filter 50, which is defined by both the other outermost ridge on the filter 50 and the other end of the filter 50.

Olefin resin is heat-resistant and chemical-resistant. This permits the support line 3 of olefin resin to keep a distance between the adjacent ridges 1 constant at extreme temperatures and conditions.

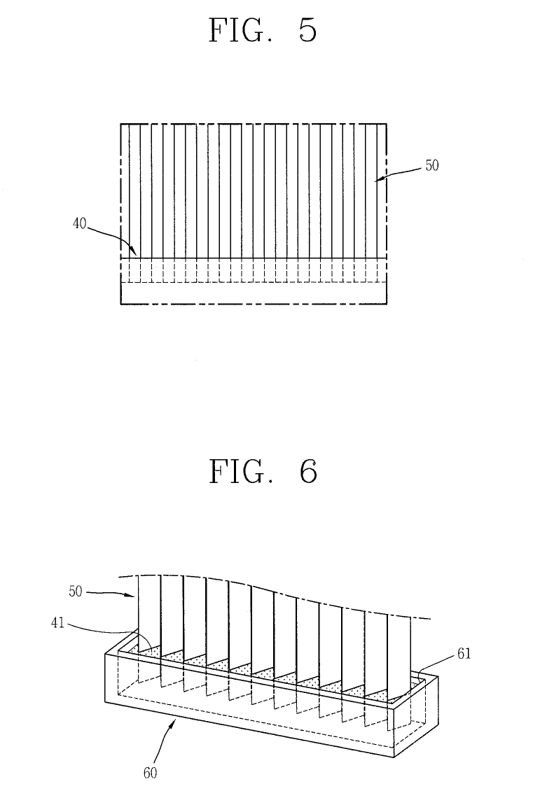

FIG. 5 is a front view of a portion of the filter assembly as shown in FIG. 2. FIG. 6 is a perspective view of a mold for casting the filter assembly as shown in FIG. 2.

As shown in FIGS, when the filter frame 40 is made of urethane resin, the filter 50 is combined with the filter frame 40, with all edges of the filter 50 being inserted into the filter frame 40.

Molten urethane resin 41 is poured into the mold 60 to form the filter frame 40. At this point, the filter 50 is combined with the filter frame 40, with all edges of the filter 50 being inserted into the filter frame 40, in the following manner.

As shown in FIG. 6, molten urethane resin 41 is poured into a rectangular pocket 61 in the mold 60. A first side of the filter 50 is immersed in the molten urethane resin 41 in the rectangular pocket 61 in the mold 60, to a given depth. The first side of the filter 50, when the molten urethane resin 41 is hardened, is removed from the rectangular pocket 61.

Molten urethane resin 41 is poured into the rectangular pocket 61 in the mold 60. A second side of the filter 50 is immersed in the molten urethane resin 41 in the rectangular pocket 61 in the mold 60, to a given depth. The second side of the filter 50, when the molten urethane resin 41 is hardened, is removed from the rectangular pocket 61.

Molten urethane resin 41 is poured into the rectangular pocket 61 in the mold 60. A third side of the filter 50 is immersed in the molten urethane resin 41 in the rectangular pocket 61 in the mold 60, to a given depth. The third side of the filter 50, when the molten urethane resin 41 is hardened, is removed from the rectangular pocket 61.

Molten urethane resin 41 is poured into the rectangular pocket 61 in the mold 60. A fourth side of the filter 50 is immersed in the molten urethane resin 41 in the rectangular pocket 61 in the mold 60, to a given depth. The fourth side of the filter 50, when the molten urethane resin 41 is hardened, is removed from the rectangular pocket 61.

In this manner, the filter frame 40 is formed that encloses the first, second, third, and fourth sides of the filter 50. This permits not only a seamless connection between the filter frame 40 and filter 50, but also a stable support of the filter 50 by the filter frame 40, without having to use an adhesive agent.

The filter frame 40 may be made of aluminum or stainless steel. In this case, the filter frame 40 and the filter 50 are attached to each other with an adhesive agent.

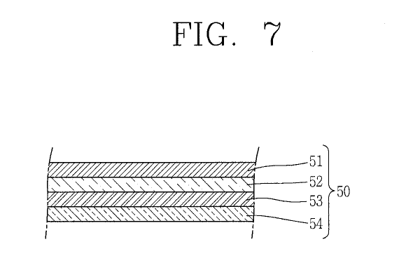

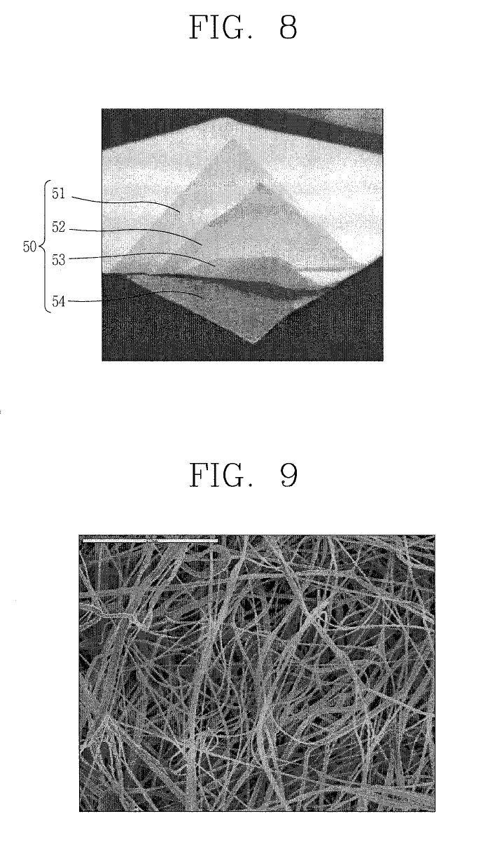

FIG. 7 is an expanded, perspective view of a portion of the filter assembly as shown in FIG. 3. FIG. 8 is a picture of a dissembled portion of the one embodiment of the filter according to the present invention.

As shown in FIGS. 7 and 8, the filter 50 according to one embodiment of the present invention, includes a first element 51, a second element 52, a third element 53, and a fourth element 54.

The fourth, third, second, and first elements 54, 53, 52, and 51 are placed on one right after the other, in this order. That is, the first (front) element 51 makes up a front face of the filter 50 and the fourth element (rear) 54 makes up a rear face of the filter 50. And the second and third elements 52 and 53 are placed between the first and fourth element 51 and 54. The first and fourth elements 51 and 54 are outermost ones. The first, second, third, and fourth elements 51, 52, 53, and 54 are attached to one right after the other, with an adhesive agent.

The adhesive agent includes EVA (ethylene vinyl acetate) resin.

The first element 51 is made from a non-woven fabric. The first element 51 is manufactured using a spun bond method which is cost-effective. As a result, the first element 51 has excellent strength and durability characteristics.

The first element 51 has pores in the body. The pores, each with a different size, are irregularly arranged. The size of the pore should be within a given tolerance. Mean size of the pores in the first element 51 may be in a range of 95 to 115 μm (included).

The first element 51 may be water-proof by coating each of strands of fiber making up the first element 51, with a waterproof agent. The waterproof agent, used in coating the strands of fiber making up the first element 51, includes fluorine polymer, emulsifier, tripropylene glycol, polyoxyethylene alkyleter, and water. The waterproof agent has the following component ratio.

The waterproof agent consists of 28.1 percent mixture of fluorine polymer and emulsifier, 7.7 percent tripropylene glycol, 2.5 percent polyoxyethylene alkyleter, and 61.7 percent water. The strands of fiber making up the first element 51 are coated with the waterproof agent, in the following manner.

The first element 51 is dipped into a container containing the waterproof agent for a given time and is drawn out of the container. The first element 51 is then pressed by a pressure roller to squeeze the surplus waterproof agent out of the first element 51. Lastly, the first element 51 is dried with a dryer. The first element 51 may be insect-repellant by coating each of strands of fiber making up the first element 51, with an insect-repellant agent.

The insect-repellant agent includes camphor or flavonoid.

Flavonoid is extracted from a cinnamomum camphora (tree). Flavonoid is extracted from a gingko (tree).

The first element 51 is dipped into the container containing waterproof agent and insect-repellant agent. As a result, the strands of fiber making up the first element 51 are coated with waterproof agent and insect-repellant agent, at the same time.

Each of the second and third elements 52 and 53 is made from a non-woven fabric. The second and third elements 52 and 53 are manufactured using a melt blown method. As a result, each of the second and third elements 52 and 53 has pliability, non-permeability, and insulation characteristics.

FIG. 9 is a picture of an expanded surface of a second or third element making up the filter as shown in FIG. 8.

As shown in FIG. 9, each of the second and third elements 52 and 53 has pores. The pores, each with a different size, are irregularly arranged. The size of the pore should be within a given tolerance. Mean size of the pores in the second and third elements 52 and 53 may be in a range of 5 to 20 μm (included).

The second and third elements 52 and 53 are water-permeable.

The fourth element 54 is made from a non-woven fabric. The fourth element 54 is manufactured using a needle punch method. The thickness of the fourth element 54 is determined by adjusting either the number of times that the needle punches the non-woven fabric, or the size of the needle.

The fourth element 54 has pores. The pores, each with a different size, are irregularly arranged. The size of the pore should be within a given tolerance. Mean size of the pores in the fourth element 54 may be in a range of 40 to 60 μm (included).

The fourth element 54 may be water-proof by coating each of strands of fiber making up the fourth element 54, with a waterproof agent.

Like the one with which to coat the strands of fiber making up the first element 51, the waterproof agent with which to coat the strands of fiber making up the fourth element 54 includes fluorine polymer, emulsifier, tripropylene glycol, polyoxyethylene alkyleter, and water. The waterproof agent has the same component ratio as the one used in coating the strands of fiber making up the first element 51.

The strands of fiber making up the fourth element 54 are coated with the waterproof agent, in the same manner as the strands of fiber making up the first element 51.

The fourth element 54 may be insect-repellant by coating each of strands of fiber making up the fourth element 54, with an insect-repellant agent.

The insect-repellant agent with which to coat the strands of fiber making up the fourth element 54 has the same components as the ones with which to coat the strands of fiber making up the first element 51.

The strands of fiber making up the fourth element 54 are coated with the insect-repellant agent in the same manner as the strands of fiber making up the first element 51.

The filter 50 according to another embodiment of the present invention includes two or more first element 51, a second element 52, a third element 53, and two or more fourth element 54. The filter 50 according to another embodiment of the present invention includes a first element 51, two or more second element 52, a third element 53, and a fourth element 54.

The filter 50 according to another embodiment of the present invention includes a first element 51, a second element 52, two or more third element 53, and a fourth element 54. Operation of the cooling apparatus equipped with the filter assembly FA according to the present invention is now described.

As shown in FIG. 1, the motor 30 rotates the fan 20. The fan 20 pulls outside air through the filter 50, installed into the inlet 11, into the housing 10. Fine dust particles and moisture are removed from the outside air passing through the filter 50. Thus, clean outside air is introduced into the housing 10.

Moisture and fine dust particles are removed from the outside air passing through the filter 50 in the following manner.

Outside air passes through the first, second, third and fourth elements 51, 52, 53, and 54, in this order. Moisture is removed from the outside air passing through the first element 51. Fine dust particles are removed from the outside air passing through the second and third elements 52 and 53.

According to experimental data, 99.99% or more of 0.3 μm fine dust particles are removed from the outside air passing through the second and third elements 52 and 53.

Moisture is further removed from the outside air, which passed through the first, second, and third elements 51, 52, and 53, passing through the fourth element 54.

Outside air, after introduced into the housing 10, picks up heat produced by the electronic device E, and then passes through the filter 50, inserted into the air outlet 12 in the housing 10, to carry away the heat. This makes the electronic device E cooler.

The filter 50 inserted into the air outlet 12 in the housing 10 prevents outside air with moisture and fine dust particle from being introduced into the housing 10.

The temperature of the electronic device E decreases with an amount of outside air introduced into the housing 10. The amount of outside air depends on the rotation speed of the fan 20. The fan 20 commonly rotates to maintain the electronic device E at the temperature of less than 65° C.

A configuration of the filter 50 (i.e., the stack of four elements of non-woven fabric) not only allows for smooth introduction of outside air into the housing 10, but also prevents production of static electricity. The filter 50 is easy to manufacture.

The waterproof first and fourth elements 51 and 54 of the filter 50 allows for effective removal of moisture from outside air passing through them. The second and third elements 52 and 53 of the filter 50 allows for effective removal of fine dust particles from outside air passing through them.

The flying insect may be drawn to the filter 50, thereby preventing smooth flow of outside air into the housing 10. The insect-repellant first and fourth element 51 and 54 of the filter 50 keeps an insect away from the filter 50.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A filter comprising elements, each being made from non-woven fabric, which are placed on one right after the other, the two outermost elements being coated with a waterproof agent.

2. A filter assembly comprising:
a filter frame; and
a filter provided on the filter frame, the filter comprising elements, each being made from non-woven fabric, which are placed on one right after the other, the two outermost elements being coated with a waterproof agent.

3. The filter assembly according to claim 2, wherein the two outermost elements is coated with an insect-repellant agent.

4. The filter assembly according to claim 2, wherein the number of the elements is 4 (four) and the four elements are placed on one right after the other and attached to the adjacent element with an adhesive agent, with the two outermost elements being coated with a waterproof agent and the insect-repellant agent.

5. The filter assembly according to claim 4, wherein the adhesive agent is EVA (ethylene vinyl acetate) resin.

6. The filter assembly according to claim 4, wherein the waterproof agent comprises:
fluorine polymer;
emulsifier;
tripropylene glycol;
polyoxyethylene alkyleter; and
water.

7. The filter assembly according to claim 6, wherein the waterproof agent consists of 28.1 percent mixture of fluorine polymer and emulsifier, 7.7 percent tripropylene glycol, 2.5 percent polyoxyethylene alkyleter, and 61.7 percent water.

8. The filter assembly according to claim 4, wherein the insect-repellant agent is camphor.

9. The filter assembly according to claim 4, wherein the insect-repellant agent is flavonoid.

10. The filter assembly according to claim 4, wherein pores in the one outermost element have different sizes, with mean size of the pores being in a range of 95 to 115 μm (included), pores in the other outermost element have different sizes, with mean size of the pores being in a range of 40 to 60 μm (included), and pores in each of the two intermediate elements have different sizes, with mean size of the pores being in a range of 5 to 20 μm (included).

11. The filter assembly according to claim 4, wherein the one outermost element is made using a spun bond method, the other outermost element is made using a needle punch method, and the two intermediate elements are made using a melt blown method.

12. The filter assembly according to claim 2, wherein the filter is shaped into alternating ridges and grooves, and the filter is combined with the filter frame, with all edges of the filter being inserted into the filter frame.

13. The filter assembly according to claim 12, wherein the filter frame is made of urethane resin.

14. The filter assembly according to claim 12, wherein support lines of olefin resin are provided on the filter to keep a given distance between the two adjacent ridges.

15. The filter assembly according to claim 14, wherein the support line is made of olefin resin.

16. The filter assembly according to claim 15, wherein a material for the support line is selected from a group consisting of poly olefin resin, ploy ethylene resin, and poly propylene resin.

17. The filter assembly according to claim 14, wherein one end of each of the support lines of olefin resin is extended to one-half to two-thirds (included) of width of one outermost inclined surface of the filter, which is defined by both the one outermost ridge on the filter and the one end of the filter, and the other end of each of the support lines of olefin resin is extended to one-half to two-thirds (included) of width of the other outermost inclined surface of the filter, which is defined by both the other outermost ridge on the filter and the other end of the filter.

18. Cooling apparatus comprising:
a housing having an air inlet and an air outlet, inside which to install an electronic device;
a fan provided inside the housing, pulling outside air into the housing;
a fan motor driving the fan, and
two filter assemblies being inserted into the air inlet and air outlet, respectively, each of the two filter assemblies comprising:
a filter frame, and
a filter provided on the filter frame, the filter comprising elements, each being made from non-woven fabric, which are placed on one right after the other, the two outermost elements being coated with a waterproof agent.
